(19) United States
(12) Patent Application Publication
(10) Pub. No.: US 2018/0243784 A1
(43) Pub. Date: Aug. 30, 2018

(54) HARDWARE ASSEMBLY ADHESIVE APPLICATOR

(71) Applicant: LIBERTY HARDWARE MFG. CORP., Winston-Salem, NC (US)

(72) Inventor: Nathaniel Faltin Dutton SCHULTZ, Charlotte, NC (US)

(21) Appl. No.: 15/442,201

(22) Filed: Feb. 24, 2017

(51) Int. Cl. B05C 9/02; A47G 1/17; B65D 1/38; A47K 3/38; A47K 10/04

(52) U.S. Cl. CPC B05C 9/02; A47G 1/17; A47K 2201/02; A47K 3/38; A47K 10/04; B65D 1/38

(57) ABSTRACT

An applicator for a reversible dry adhesive is provided with a flexible substrate with a convex application surface in an unloaded condition of the flexible substrate. A reversible dry adhesive is spread across the application surface to provide a focused partial contact with a generally flat target support surface. Compression of the substrate expands contact of the reversible dry adhesive with the target support surface outward from the focused contact. A hardware assembly is provided with a hardware component for installation to the target support surface upon the reversible dry adhesive. A method of installing the reversible dry adhesive applies the focused partial contact of the reversible dry adhesive to the generally flat target support surface.

### TECHNICAL FIELD

Various embodiments are related to applicators for adhesives and related hardware.

### BACKGROUND

An application of a reversible dry adhesive for a shower rod assembly is disclosed in U.S. application Ser. No. 14/048,553, filed on Oct. 8, 2013, and issued on Jan. 31, 2017 as U.S. Pat. No. 9,554,674 B2.

### SUMMARY

According to at least one embodiment, an applicator for a reversible dry adhesive is provided with a flexible substrate with a convex application surface in an unloaded condition of the flexible substrate. A reversible dry adhesive is spread across the application surface to provide a focused partial contact with a generally flat target support surface. Compression of the substrate expands contact of the reversible dry adhesive with the target support surface outward from the focused contact.

According to another embodiment, a shower rod assembly is provided with a shower rod with a pair of terminal ends. A pair of applicators are each provided with a flexible substrate with a convex application surface in an unloaded condition of the flexible substrate. A reversible dry adhesive is spread across the application surface to provide a focused partial contact with a generally flat target support surface. Compression of the substrate expands contact of the reversible dry adhesive with the target support surface outward from the focused contact. Each of the pair of applicators is in receipt of one of the pair of shower rod terminal ends in the corresponding receptacle.

According to another embodiment, a towel bar assembly is provided with a towel bar with at least one terminal post. At least one applicator is provided with a flexible substrate with a convex application surface in an unloaded condition of the flexible substrate. A reversible dry adhesive is spread across the application surface to provide a focused partial contact with a generally flat target support surface. Compression of the substrate expands contact of the reversible dry adhesive with the target support surface outward from the focused contact. The at least one applicator is in receipt of the at least one towel bar terminal post in the receptacle.

According to another embodiment, a mirror assembly is provided with a mirror with at least one terminal post. At least one applicator is provided with a flexible substrate with a convex application surface in an unloaded condition of the flexible substrate. A reversible dry adhesive is spread across the application surface to provide a focused partial contact with a generally flat target support surface. Compression of the substrate expands contact of the reversible dry adhesive with the target support surface outward from the focused contact. The at least one applicator is in receipt of the at least one mirror terminal post in the receptacle.

According to another embodiment, a basket assembly is provided with a basket with at least one terminal post. At least one applicator is provided with a flexible substrate with a convex application surface in an unloaded condition of the flexible substrate. A reversible dry adhesive is spread across the application surface to provide a focused partial contact with a generally flat target support surface. Compression of the substrate expands contact of the reversible dry adhesive with the target support surface outward from the focused contact. The at least one applicator is in receipt of the at least one basket terminal post in the receptacle.

According to another embodiment, a method of installing a reversible dry adhesive provides an applicator with a convex application surface. A reversible dry adhesive is provided on the convex application surface. A focused partial contact of the reversible dry adhesive is applied to a generally flat target support surface.

According to another embodiment, a hardware assembly is provided with an applicator with a flexible substrate with a convex application surface in an unloaded condition of the flexible substrate. A reversible dry adhesive is spread across the application surface to provide a focused partial contact with a generally flat target support surface. Compression of the substrate expands contact of the reversible dry adhesive with the target support surface outward from the focused contact. A hardware component is provided for installation to the target support surface upon the reversible dry adhesive.

### BRIEF DESCRIPTION OF THE DRAWINGS

FIG. 1 is a partial section view of an adhesive applicator according to an embodiment;

FIG. 2 is another partial section view of the adhesive applicator of FIG. 1, illustrated during installation;

FIG. 3 is another partial section view of the adhesive applicator of FIG. 1, illustrated in another position during installation;

FIG. 4 is another partial section view of the adhesive applicator of FIG. 1, illustrated in another position during installation;

FIG. 5 is a perspective view of a shower curtain rod assembly according to an embodiment;

FIG. 6 is a perspective view of a towel bar assembly according to an embodiment;

FIG. 7 is a perspective view of a mirror assembly according to an embodiment;

FIG. 8 is a perspective view of a shelf assembly according to an embodiment; and

FIG. 9 is a perspective view of a basket assembly according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

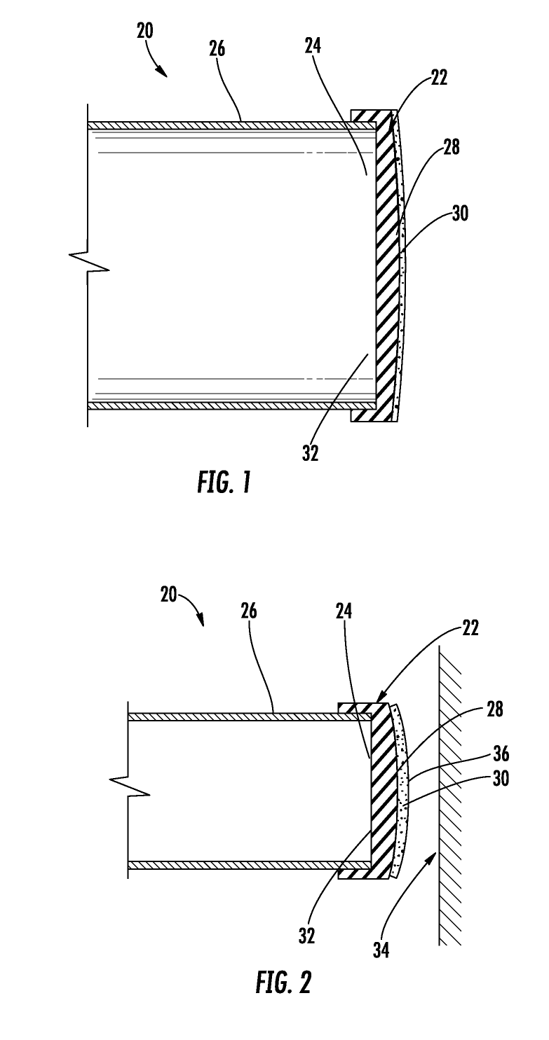

FIG. 1 depicts an applicator 20 according to an embodiment, to apply an adhesive to a substrate, or flat target support surface. The applicator 20 may be utilized for applying a reversible dry adhesive, such as styrene ethylene butylene styrene (SEBS), a silicone-based adhesive, or the like. The applicator 20 permits that adhesive to conform to the substrate during the application process due to material properties and geometries. The applicator 20 permits the adhesive to be removed from the target surface as well. The applicator 20 permits the adhesive to be removed from the target surface with ease due the geometry of the applicator. A reverse application force peels the adhesive as explained below.

The applicator 20 includes a flexible substrate 22 formed from an elastomeric material with a low durometer hardness. The substrate 22 may include a receptacle 24 for receipt of a handle 26. The handle 26 may be formed integrally with the substrate 22. In the depicted embodiment, the handle 26 is generally tubular and detachable from the receptacle 24. The handle 26 may be a support post of a hardware assembly for attachment of the hardware assembly to the target support surface. Alternatively, the substrate 22 may be formed with an integral handle 26. As another alternative, the receptacle 24 may extend significantly from the substrate to provide the handle 26.

The flexible substrate 22 has an application surface 28 that is convex in an unloaded condition of the substrate 22. A reversible dry adhesive 30 is spread across the application surface 28. The reversible dry adhesive 30 may be spread across the application surface 28 consistently with a uniform thickness. By attaching the reversible dry adhesive 30 to the applicator substrate 22, which is highly elastic and naturally maintains a convex shape at the application surface 28, many benefits for installation and removal of the reversible dry adhesive 30 to and from the support surface are achieved.

Due to the generally uniform thickness of the reversible dry adhesive 30 spread across the convex application surface 28, the reversible dry adhesive 30 also attains a convex shape in the unloaded condition of the substrate 22. The region behind the substrate 22 may include a cavity 32. The cavity 32 can be provided in the receptacle 24, within the tubular handle 26, or collectively within the receptacle 24 and the handle 26 as depicted in FIG. 1. The cavity 32 aids in enabling the convex application surface 28 to deform upon loading and collapse to a flat surface 28. In this embodiment, the substrate 22 with the receptacle 24 also provides a cap at an end of the otherwise open tubular handle 26. After the substrate 22 is loaded, and then unloaded, the substrate 22 returns to the unloaded position of FIG. 1 due to the elastic properties of the material of the substrate 22.

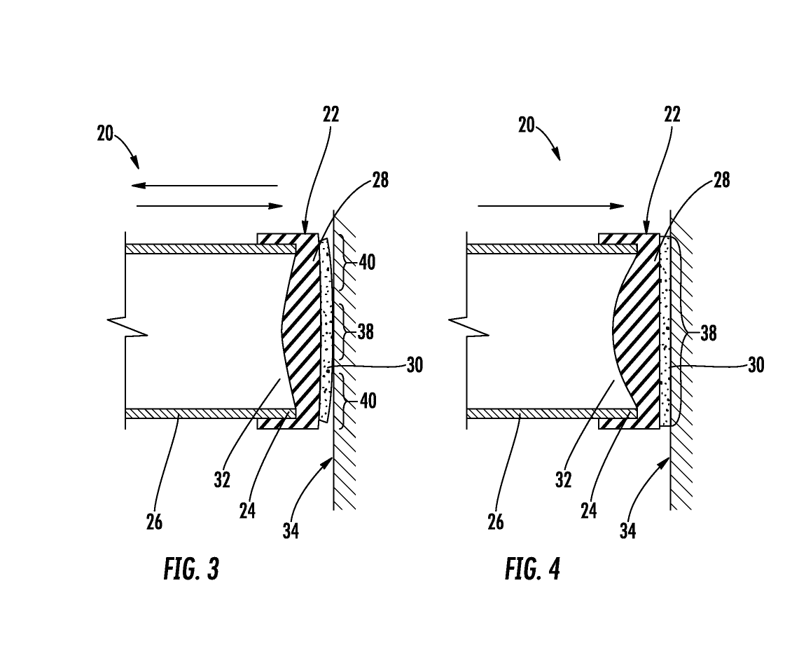

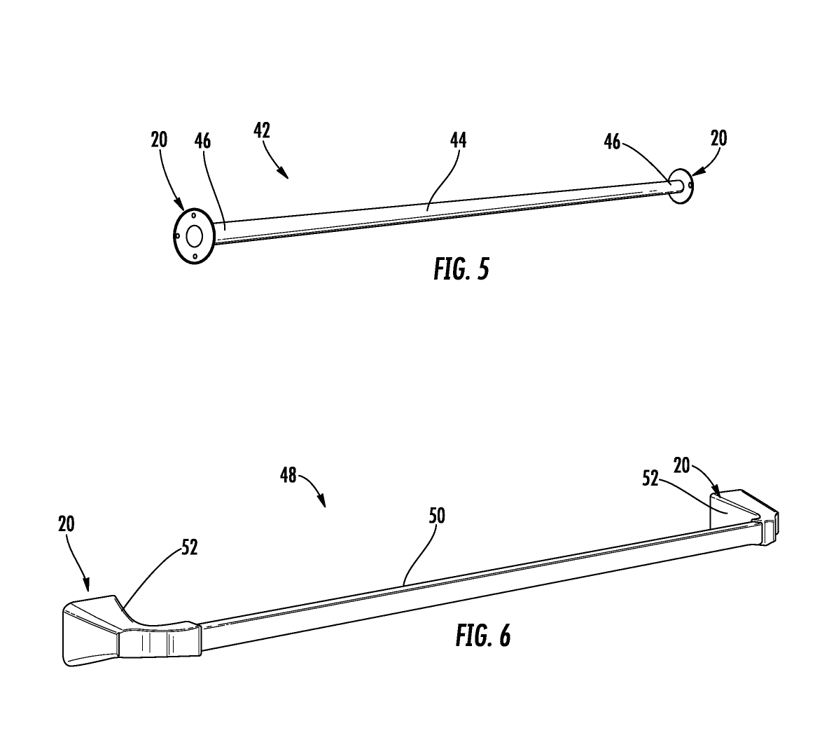

With reference to FIG. 2, the applicator 20 is illustrated presented to a generally flat target support surface 34. Due to convex form factor of both the substrate application surface 28 and the outer-most reversible dry adhesive material 30, when the outer-most adhesive material (or SEBS) first comes into contact with the intended surface only a small, singular, focused initial point 36 of contact is created. Then, as the applicator 20 is pressed further towards the target support surface 34 as illustrated in FIG. 3, the point of contact 36 expands radially outward to a contact area of conformance 38 increases outwards as the base material with a low durometer hardness under the reversible dry adhesive 30 conforms to the flat support surface 34. FIG. 4 illustrates further loading and deformation of the substrate 22, thereby further expanding the contact area of conformance 38 to fully include the entire reversible dry adhesive material 30.

This method of initiating contact of the reversible dry adhesive 30 in a single central location at contact point 36 in FIG. 2, and then spreading the area of contact 38 outwards (FIG. 3 and then FIG. 4) prevents one or more air pockets from being trapped within the conforming area 38. This method of applying the reversible dry adhesive 30 allows the applicator 20 to achieve a full area of conformance 38 between the outer-most reversible dry adhesive material 30 and the target surface 34 producing the greatest shear force strength for the assembly.

In an application whereby the outer-most surface of the reversible dry adhesive 30 contacts the target surface 34 at an angle other than the handle 26 oriented perpendicular to the target surface 34, due to the convex formation of both the outer-most surface of the reversible dry adhesive 30 and the substrate 22, when unloaded only a small point of contact 36 is made between the reversible dry adhesive 30 and the target surface 34. When the applicator 20 is pressed into the intended surface 34 forcing the low durometer substrate 22 to deform, the outer-most material of the reversible dry adhesive 30 also deforms from its convex shape to the flat state to result in the full conformance of FIG. 4.

When the reversible dry adhesive 30 is to be withdrawn from the connecting surface 34, the applicator is retracted from the target surface 34, from the position of FIG. 4 to the position of FIG. 3, and subsequently to the position of FIG. 2. This motion withdraws the compression upon the substrate 22, permitting the substrate 22, and consequently the reversible dry adhesive 30 to elastically return to its initial convex form factor. This restorative force causes the outermost (perimeter) edges 40 of the contact area of conformance 38 in FIG. 3 to withdraw from the target surface 34 before the rest of the contact surface 38. By withdrawing the outer perimeter 40 from the target surface 34, the reversible dry adhesive 30 is withdrawn under peel as the greatest restorative forces are concentrated around the outer perimeter 40 of the contact surface 38. This peeling motion of the exterior surface 40 away from the target surface 34 continues as the applicator 20 is withdrawn from contact. For reversible dry adhesives, the adhesive properties of the outer-most material 40 are weakest in peel and thus permit removal with a reduced force. The peel characteristic is possible independent of the angle at which the applicator 20 is withdrawn from the target surface 34.

According to at least one embodiment, the substrate 22 and the reversible dry adhesive 30 may be formed integrally. For example, the substrate 22 and the reversible dry adhesive 30 may be formed from a molded silicone material which may have both the desired durometer hardness as well as a surface with the desired coefficient of friction.

The mechanical benefits gained when pairing convex application surface 28 with a reversible dry adhesive 30 provides resistance to sheer forces for supporting components such as hardware, while relatively weak in resisting peel forces to permit installation and removal. The reversible dry adhesive 30 is most effective when no regions of nonconformance are present between the contact surface 38 and the support surface 34.

Reversible dry adhesives 30 have proven desirable in the bathroom hardware environment, wherein support surfaces such as glass, acrylic, tile and the like are present. In these environments, a consumer desires fasteners that do not require drilling or other permanent modifications to the support surface. The ability to install and remove reversible dry adhesives without damaging the support surface permits interchangeability for modification and design updates to the hardware within the bathroom environment. Unlike suction cups, the reversible dry adhesive 30 can withstand the applied force in shear over a life cycle of the installed hardware. The applicator 20 is also more compact than other alternatives to avoid obfuscation of the installed design when the applicator 20 is installed with the applicable hardware.

FIG. 5 illustrates a shower curtain rod assembly 42 according to an embodiment, for supporting a shower curtain between a pair of opposed support surfaces 34. The shower curtain rod assembly 42 includes a shower rod 44, which may have an adjustable length according to an embodiment. The shower rod 44 includes a pair of terminal ends 46. Each terminal end 46 is received in a receptacle 24 of an applicator 20. As the shower rod 44 is lengthened, the applicators 20 contact the support surfaces 34, and spread the reversible dry adhesive 30 as the applicators deform under compression as described. The applicators 20 are components of the assembled shower curtain rod assembly 42 and may be designed or styled with an appearance to correspond with the desired installed design of the shower curtain rod assembly 42. The shower curtain rod assembly 42 can be packaged with the pair of applicators 20 for convenience in retail and installation for the end consumer.

FIG. 6 illustrates a towel bar assembly 48 according to another embodiment, for supporting a towel from an upright flat support surface 34. The towel bar assembly 48 includes a towel bar 50 received in a pair of terminal posts 52. Each terminal post 52 is received in a receptacle of an applicator 20.

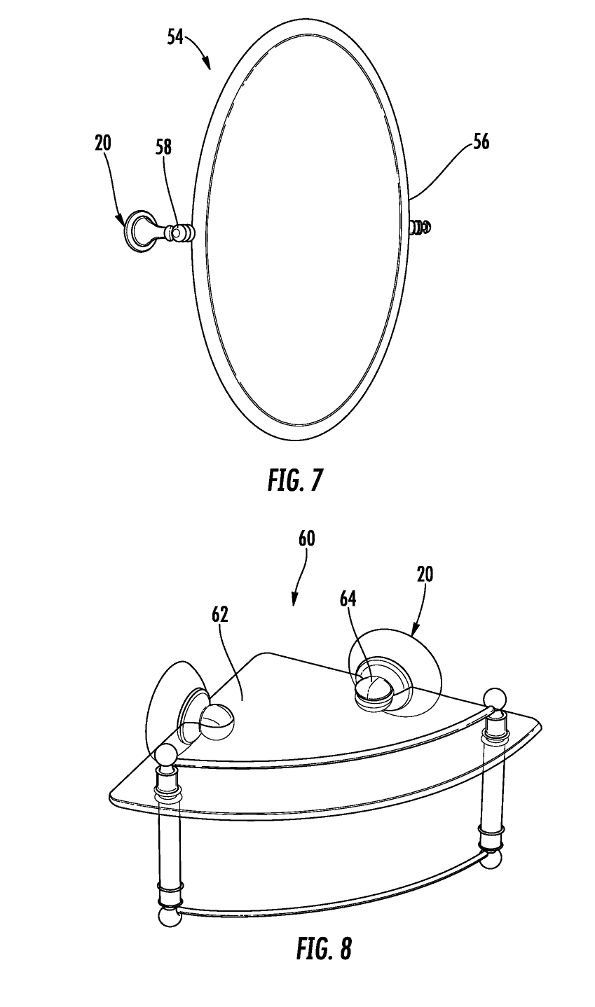

FIG. 7 illustrates a mirror assembly 54 according to another embodiment. The mirror assembly 54 includes a mirror 56 connected to a terminal post 58. The terminal post 58 is received in the receptacle 24 of an applicator 20 for installation upon an upright support surface 34.

FIG. 8 illustrates a shower caddy or shelf assembly 60 according to another embodiment. The shelf assembly 60 includes a shelf 62 connected to a pair of terminal posts 64. Each terminal post 64 is supported by an applicator 20 for installation upon a pair of intersecting support surfaces 34 or a single upright support surface 34.

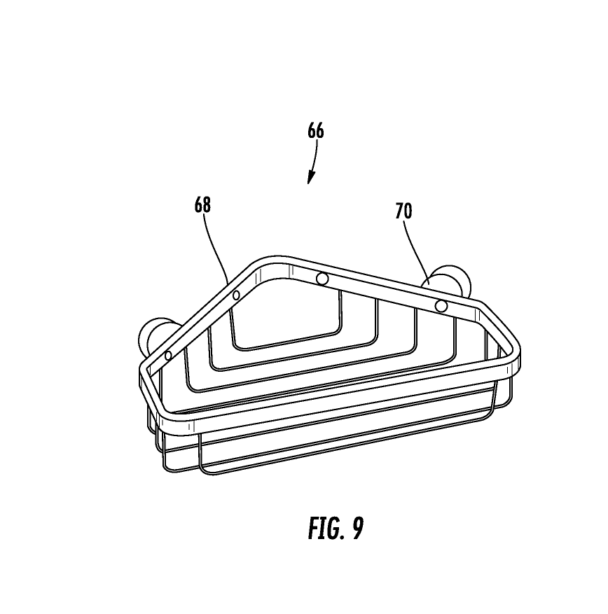

FIG. 9 illustrates another shower caddy as a basket assembly 66 according to an embodiment. The basket assembly 66 includes a basket 68 connected to a pair of terminal posts 70. The posts 70 are each sized to be mounted within a receptacle of one of the applicators 20 for installation upon a pair of intersecting support surfaces 34 or a single upright support surface 34.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An adhesive applicator comprising:
a flexible substrate with a convex application surface in an unloaded condition of the flexible substrate; and
a reversible dry adhesive spread across the application surface to provide a focused partial contact with a generally flat target support surface, and whereby compression of the substrate expands contact of the reversible dry adhesive with the target support surface outward from the focused contact.

2. The applicator of claim 1 wherein the reversible dry adhesive has a generally uniform thickness.

3. The applicator of claim 1 wherein the reversible dry adhesive comprises styrene ethylene butylene styrene.

4. The applicator of claim 1 wherein the reversible dry adhesive comprises silicone.

5. The applicator of claim 1 wherein the substrate is formed from an elastomeric material.

6. The applicator of claim 1 wherein the substrate collapses to result in a generally planar application surface during deformation for installation of the reversible dry adhesive.

7. The applicator of claim 1 further comprising a handle extending from the flexible substrate opposed from the application surface.

8. The applicator of claim 7 wherein the handle is tubular and detachable from the flexible substrate.

9. The applicator of claim 1 wherein the substrate comprises a receptacle to receive hardware.

10. A shower rod assembly comprising:
a shower rod with a pair of terminal ends; and
a pair of applicators, each according to claim 9, and each of the pair of applicators in receipt of one of the pair of shower rod terminal ends in the corresponding receptacle.

11. A towel bar assembly comprising:
a towel bar with at least one terminal post; and
at least one applicator according to claim 9 in receipt of the at least one towel bar terminal post in the receptacle.

12. A mirror assembly comprising:
a mirror with at least one terminal post; and
an applicator according to claim 9 in receipt of the at least one terminal post in the receptacle.

13. A basket assembly comprising:
a basket with at least one terminal post; and
an applicator according to claim 9 in receipt of the at least one terminal post in the receptacle.

14. A method of installing an adhesive comprising:
providing an applicator with a convex application surface;
providing a reversible dry adhesive on the convex application surface; and
applying a focused partial contact of the reversible dry adhesive to a generally flat target support surface.

15. The method of claim 14 further comprising applying a force to the applicator to deform the application surface and the reversible dry adhesive to expand contact of the reversible dry adhesive with the target support surface.

16. The method of claim 14 further comprising assembling hardware to the reversible dry adhesive.

17. The method of claim 14 further comprising assembling hardware to the applicator.

18. The method of claim 14 further comprising packaging the applicator and the reversible dry adhesive with hardware for retail.

19. A hardware assembly comprising:
an applicator with a flexible substrate with a convex application surface in an unloaded condition of the flexible substrate;
a reversible dry adhesive spread across the application surface to provide a focused partial contact with a generally flat target support surface, and whereby compression of the substrate expands contact of the reversible dry adhesive with the target support surface outward from the focused contact; and
a hardware component for installation to the target support surface upon the reversible dry adhesive.

20. The hardware assembly of claim 19 further comprising retail packaging sized to collectively retain the applicator, the reversible dry adhesive and the hardware component.
